(19) United States
(12) Patent Application Publication
(10) Pub. No.: US 2025/0340406 A1
(43) Pub. Date: Nov. 6, 2025

(54) LOAD ALIGNMENT CONTROL SYSTEM AND METHOD THEREFOR

(71) Applicant: DELTA LABORATORIES HOLDING B.V., Rotterdam (NL)

(72) Inventor: André SCHIELE, Rotterdam (NL)

(21) Appl. No.: 18/870,407

(22) PCT Filed: Jun. 2, 2023
(86) PCT No.: PCT/IB2023/000321

§ 371 Date: Nov. 28, 2024

(30) Foreign Application Priority Data
Jun. 2, 2022 (NL) 2032063

(51) Int. Cl. B66C 13/08; B66C 13/06; B66C 13/40; B66C 13/46; B66C 13/48; B66C 23/18; B66C 23/52

(52) U.S. Cl. CPC B66C 13/085; B66C 13/063; B66C 13/46; B66C 13/48; B66C 23/185; B66C 23/52; B66C 13/40

(57) ABSTRACT

The invention relates to a control system and method for controlling alignment of a load suspended from a crane with a target. The method incudes determining motion of the load in at least one Degree of Freedom, generating a compensation signal indicative of motion of the load, and generating. in response to the at least one compensation signal. control signals for a crane and/or load motion compensation system LMCS for controlling a reference pose of the load within a reference coordinate system provided by a first reference sensor. The method further includes receiving from a feature detection system a relative movement signal indicative of relative movement between the target and the load; generating an alignment signal in response to the relative movement signal, and generating, in response to the alignment signal, control signals for controlling a crane and/or LMCS for moving the load in alignment with the target.

### TECHNICAL FIELD

The present invention relates to a control system for controlling alignment of a load suspended from a crane with a target. In particular; the invention relates to a load motion compensation system expanded with a load alignment system. The invention further relates to a method for controlling alignment of a load suspended from a crane with a target.

### BACKGROUND ART

Installation of offshore wind turbines is a complicated matter. For one, components such as the nacelle and the turbine blades have to be lifted off the deck of an installation vessel by a crane, or other lifting device, up to large heights, for example up to 150 meters or higher. Furthermore, the components have to be assembled at that height with high precision whilst being suspended from the crane. The installation may be made even more difficult by the conditions off-shore, such as by winds and waves which may exert disturbance motions on the installation vessel, on the components that are suspended in the air and being lifted by the crane, and/or disturbance motions on the target structure to which the installation needs to be performed.

For decoupling the installation vessel from the influence of currents, and waves, a jack-up vessel may be used. However, jack-up vessels have a limited working area and limited usability in different waters, due to the limitation in the height of the jack-up legs on which the vessel can be lifted. Although the effect of the waves and wind on the installation vessel may be reduced by jacking the vessel up, wind and/or wave forces on all elements may still move the components suspended from the crane.

As an alternative to a jack-up vessel and conventional crane, a motion compensating crane or stabilization platform may be used on a floating vessel. Such a crane is arranged to keep the load suspending from it on substantially the same position and orientation while the base of the crane moves with the vessels movements caused by winds and waves because it is rigidly attached to the vessel for at least some degrees of freedom. However, such motion compensating cranes may be heavy, require a lot of energy to operate, and/or have a limited working range or load capacity, especially on the vertical range.

An alternative motion compensation system is known from WO2021/002749A1, which discloses a load motion compensation system (LMCS) consisting of a crane having a hoist, such as cable hoist or hydraulic gripper, and a number of actuators i.e. combinations of cables and winches which are controlled to compensate for the motion due to wind and water. The position of the hoist and of a suspended load may be expressed as a three-dimensional coordinate in a Cartesian coordinate system comprising three orthogonal translational axes. The orientation of the hoist may be expressed as a set of three angles, which angles refer to an amount of degrees of rotation around a translation axis. Any other notation may be used for positions, orientations or combinations thereof, such as angle-axis coordinates, homogeneous coordinates, etc. In combination, position and orientation is called the pose of an object. A number of force sensors are arranged to provide sensor signals indicating the tension on one or more of the cables. The sensor tension signals are received by a control system which is arranged to control the winches based on the signals received. Accordingly, the system disclosed in WO2021/002749A1 enables to compensate the load for motions due to wind and water or induced by any other factor, and maintain a pose of the load within a (geo) reference coordinate system, which is preferably based on Global Positioning System (GPS) or any other geolocation information.

When mounted on a vessel, and independent from whether the vessel is of a floating type or of a jackup type, the load motion compensation system alleviates the task of installing the load, such as a wind turbine blade, towards a target, such as a nacelle or rotor of a wind turbine. In the case of using such motion compensation system on a jackup, it allows to install at higher wind-speeds than when no such compensation system is used and it allows to install a load also when the target (e.g. nacelle) exhibits a motion.

### SUMMARY OF INVENTION

It is an object of the invention to facilitate alignment of a load with a target. Thereto, in a first aspect, the disclosure relates to a computer implemented method for controlling alignment of a load suspended from a crane with a target. The method includes determining motion of the load in at least one Degree of Freedom, generating at least one compensation signal indicative of motion of the load; and generating, in response to the at least one compensation signal, control signals for a crane and/or load motion compensation system (LMCS) for controlling a reference pose of the load within a reference coordinate system provided by a first reference sensor. The method further includes receiving from a feature detection system a relative movement signal indicative of relative movement between the target and the load; and generating, in response to the relative movement signal, control signals for controlling a crane and/or LMCS for displacement of the load towards the target.

According to another aspect, there is a control box for controlling alignment of a load suspended from a crane with a target.

According to another aspect, there is provided a control system for controlling alignment of a load suspended from a crane with a target.

According to another aspect, there is provided a method for controlling alignment of a load suspended from a crane with a target.

According to another aspect, there is provided a crane including a control system as disclosed.

According to another aspect, there is provided a vessel including a crane and a control system as disclosed.

Particular embodiments of the invention are set forth in the dependent claims.

Further objects, aspects, effects and details of particular embodiments of the invention are described in the following detailed description of a number of exemplary embodiments, with reference to the drawings.

### BRIEF DESCRIPTION OF DRAWINGS

By way of example only, the embodiments of the present disclosure will be described with reference to the accompanying drawing, wherein:

FIG. 1 illustrates schematically an example of a load suspended by a crane mounted on a vessel;

FIG. 2 illustrates schematically an example of various mounting arrangements for a target;

FIG. 3 illustrates schematically an example of a control system for controlling alignment of a load with a target in accordance with the invention;

FIG. 4 illustrates schematically an example of a sensor arrangement for a vessel mounted crane in accordance with the invention;

FIG. 5 illustrates schematically an example of a feature and feature detection system in accordance with the invention;

FIG. 6 illustrates schematically a point of view of the feature detection system of FIG. 5;

FIG. 7 illustrates schematically an example of a method for controlling alignment of a load and a target in accordance with the invention;

FIG. 8 illustrates schematically an example of a control scheme of the control system in accordance with the invention;

FIG. 9 illustrates schematically another example of a feature; a feature detection system and a feature plate in accordance with the invention;

FIG. 10 illustrates schematically an example of a feature plate mounted on bolts of load in accordance with the invention;

FIG. 11 illustrates schematically another example of a method for controlling alignment of a load and a target in accordance with the invention.

### DESCRIPTION OF EMBODIMENTS

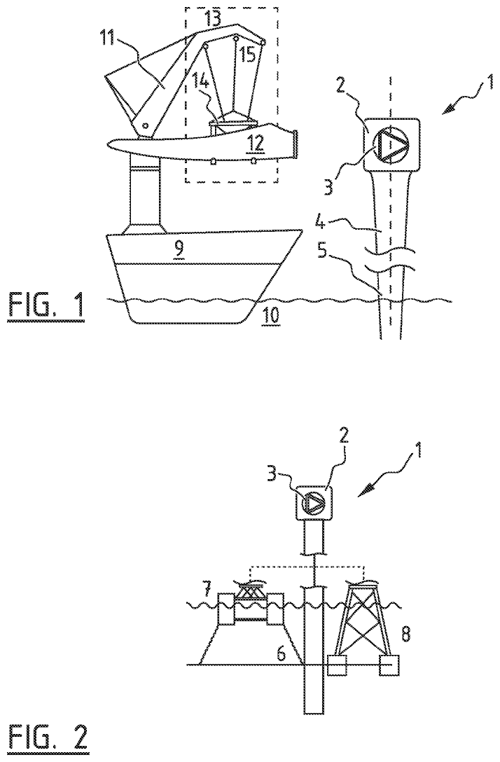

Referring to FIG. 1, a wind turbine generator 1 in progress of installation is shown. A nacelle 2 having a rotor 3 is mounted on top of a tower 4. The tower 4 is mounted upon a foundation 5 which may be provided in various ways. For example, as shown in FIG. 2, the foundation 5 may be provided by the ocean floor 6 via a so called monopile, there may be a floating foundation 7, or there may be a fixed jacket 8, or any other suitable foundation type. The floating foundation 7 may be anchored to the ocean floor by cables or chains. The fixed jacket 8 may be resting on or mounted with piles on the ocean floor.

Further shown in FIG. 1 is a vessel 9 at sea 10 carrying a crane 11 from which a load 12, such as a wind turbine blade, is suspended. The crane 11 is arranged to provide for various degrees of freedom, and may move and articulate in various manners. The crane 11 is further equipped with a hoist system 13 having a tool 14 carrying the load 12, such as e.g. a cable hoist, winch hook, hydraulic gripper, or other type of device for holding a load. Actuators 15 of the hoist system 13 control the pose, that is the position and orientation, of the tool 14 and therewith also of the load 12. The load 12 is preferably rigidly connected to the tool 14, to ensure that manipulating the pose of the tool 14 directly affects the pose of the load 12. In some embodiments, some form of mechanical or controlled compliance may be present between the tool 14 and the load 12. In some embodiments, the tool may be suited to directly grip and carry the load 12 while holding the load 12 in a rigid grip. In some examples the load may include a dedicated structure enclosing an element that is to be lifted and displaced. In this example, concerning installation of a wind turbine, the load concerns a wind turbine blade that is to be aligned with a target, the nacelle 2 in this example, in order to be installed thereon. Alternatively, any other component may be considered a load, e.g. a monopile, a transition piece, a tower or tower section, a nacelle, rotor or any other part requiring assembly. Each of the components shown in FIG. 1, including the load i.e. blade 12, the target i.e. nacelle 2 and the tower 4, may experience or cause motions due to waves and winds.

In general, in this disclosure a crane may be any device suited for lifting and displacing a load. It may for example include several articulated arms on a rotating platform. It may include an articulated tower of some sort. Or it may include one or more towers with e.g. sliders and/or girders. Furthermore, it may for example include a multitude of winches and hoists in combination with an articulated tower. It may combine a crane with another serial or parallel structure, forming a closed-loop or an open-loop mechanism that may act on the load on one or multiple points. It may consist of a serial or parallel mechanism directly holding a load.

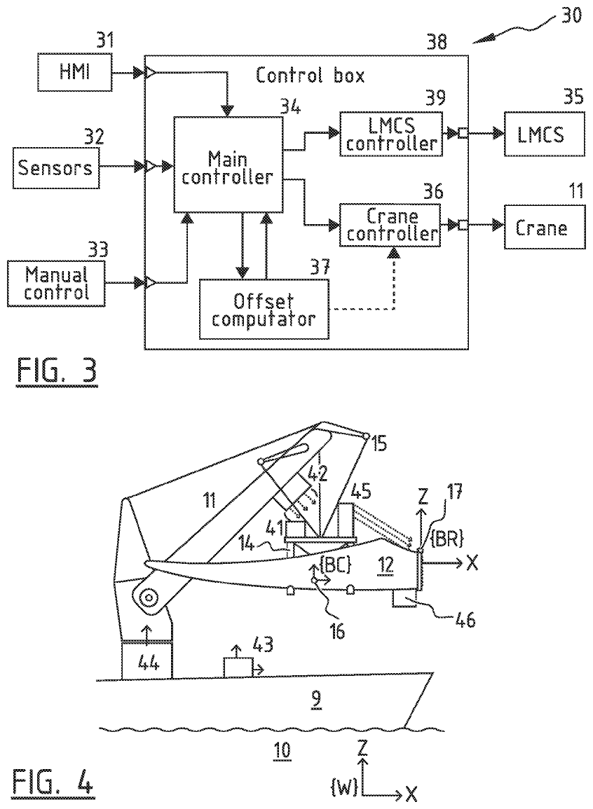

Referring to FIG. 3, a control system 30 is shown for controlling alignment of a load with a target. The control system 30 includes a control box 38 with at least one controller, in this example a main controller 34 to which various elements are connected that provide input signals, such as an operator or human-machine interface (HMI) 31, a plurality of sensors 32, and manual controls 33. In turn, the main controller 34 provides output signals to various elements, such as a load motion compensation system (LMCS) 35 and/or a crane 11. And the control system 30 may include a load alignment system, here represented as part of the various sensors 32.

The at least one controller 34 of the control box 38 may be configured for generating an alignment signal in response to a relative movement signal. And generating control signals, in response to the alignment signal, for controlling displacement of the load towards the target by controlling the LCMS 35 and/or the crane. The relative movement signal is indicative of relative movement between the target and the load. The relative movement signal may be received from a sensor or a detection system including multiple sensors, as elaborated further below. The alignment signal is generated to provide e.g. one or multiple target set points for the control system to control various actuators. In a more simple case, the alignment signal may be identical with the relative movement signal. Dependent on the setup or configuration of the control system, the alignment signal may be expressed in various other forms or formats. In a first aspect, the alignment signal aims to enable the load to move in conjunction with the target, as in a synchronized manner, even if an offset may remain present. In a second aspect, the alignment signal may aim to reduce an offset. And more preferably may aim to have corresponding structural features of load and target to face and/or engage one another. The alignment signal may be derived by feedback control, e.g. such as applicable during visual servoing and may directly drive the LCMS.

As will be understood, the main controller may perform all these functions or it may include additional dedicated controllers. For example, the control box 38 may include a load motion compensation system LMCS controller 39 for generating the LCMS control signals. The control box 38 may include an offset computator 37 for generating the alignment signal. And it may include a crane controller 36 for generating the crane control signals. In an alternative embodiment, each of the constituting components of the control box may be arranged in a distributed setup, meaning that at least one or more of the controllers and/or computator may be provided remotely and connected via cables or wirelessly to the main controller.

In general, the generating of signals may be performed sequentially or in parallel or signals may be combined. This may depend on the type of computing resources and algorithms applied. Furthermore, the generating of signals may be continuous and consequently result in time-varying signals. Accordingly, generating of one signal may trigger the generating of an additional signal in response thereto, while still continuously generating the one signal. For example, where control signals are generated in response to the alignment signal, this may be interpreted as generating the control signals in dependence of the alignment signal being generated, or in other words the controls signals are generated in relation to the alignment signal being generated. For example, the control signal may be generated directly based on the relative movement signal by applying a feedback control law, such as used during Visual Servoing, which will be familiar to the person skilled in the art. In this case, the relative movement signal and the alignment signal may be combined and also the control signal may be combined. In such case, the compensation signal may also be combined with the control signal and the processing may not involve expressing the compensation signal in an absolute reference but applying directly a relative reference in response to the relative motion signal.

The operator or human-machine-interface HMI 31 may take any form, such as a joystick, a touch-screen, a display with SCADA system, buttons, a Graphical User Interface, or any other form that may enable an operator to provide an input to the main controller 34. Alternatively, the HMI 31 may also provide an input directly to an LMCS controller 39 or a crane controller 36. In addition, an operator may provide input manually via the manual controls 33. The manual controls 33 may include one or more joysticks, control sticks, push-buttons, rotary knobs, a space-mouse, a mouse, a micro-manipulator or any other human manual input device. The input of each of the HMI 31 and manual controls 33 may be used by the main controller 34 to generate a set-point. The set-point may be output to the crane controller 36 for moving the load suspended from the crane. And/or it may be output to the LMCS 35 to control the pose of the load 12. The crane controller 36 is configured to control the crane 11 to move and articulate, depending on the type of crane, in accordance with the set-point if provided.

The LMCS 35 is configured to control a reference pose of the load, preferably an absolute reference pose. The reference pose, including a position and an orientation, may be the set-point received from the main controller 34. It may also be configured to be interpreted as either a relative pose or an absolute pose with respect to a target, which may be expressed either with regard to an Earth Coordinate Reference System or with regard to a reference Coordinate Reference System. Such Earth Coordinate Reference System may be derived via a global positioning system GPS, Beidu, Glonass, Galileo or any other currently known global position system (GNSS). The LMCS 35 may include at least one motion sensor arranged for determining movement of the load in at least one, preferably two Degrees of Freedom. The at least one motion sensor is further arranged for generating at least one compensation signal indicative of motion of the load. The LMCS 35 further includes at least one motion compensation actuator arranged for controlling a pose of the load in response to the at least one compensation signal. The load motion compensation system may further be configured for processing the compensation signal and activating the motion compensation actuator for controlling the pose of the load at the, preferably absolute, reference pose. Or alternatively directly relative to a target.

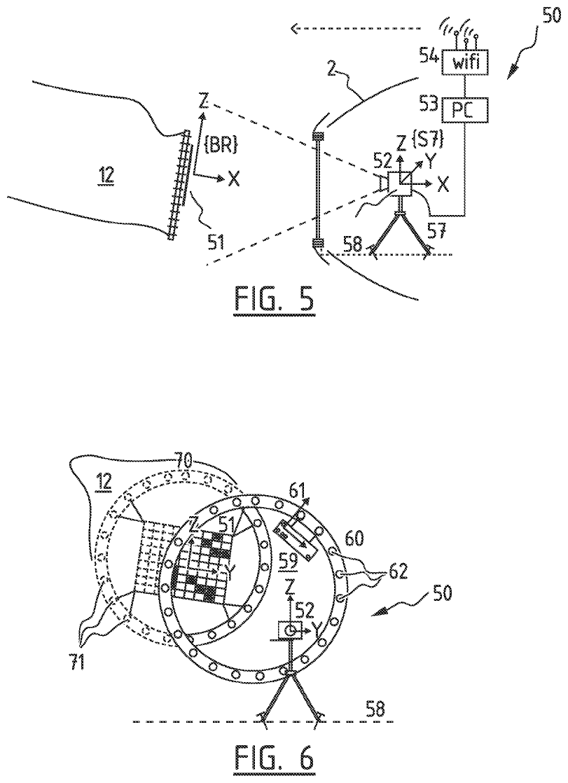

Referring to FIG. 5, the load alignment system includes a feature 51; which may be arranged on the load 12 or on the target 2 and a feature detection system 50 arranged respectively on the target 2 or on the load 12. So depending on which component, load or target, the feature 51 is arranged, the feature detection system 50 will be arranged on the other component, target or load. The feature detection system 50 is configured for detecting the feature 51, tracking movement of the feature 51, and generating the relative movement signal indicative of relative movement between the target and the load.

The load alignment system may further include an offset computator 37 for generating an alignment signal in response to the relative movement signal. The offset computator may be a dedicated computing resource, as in the embodiment of FIG. 3, or it may be provided as part of the main controller 34. Either way, the functionality of the offset computator for generating an alignment signal in response to the relative movement signal can be provided. The generated alignment signal may be transmitted to the crane controller 36 by the main controller 34. Or via the main controller 34 when generated by a dedicated offset computator 37. Or it may be transmitted by a dedicated offset computator 37 directly to the crane controller 36, as indicated by the dotted line in FIG. 3. The crane controller 36 is configured for controlling the crane 11 for displacement of the load towards the target in response to the alignment signal. Alternatively, or additionally, the generated alignment signal may be transmitted to the LMCS controller 39 by the main controller 34. Or via the main controller 34 when generated by a dedicated offset computator 37. Or it may be transmitted by a dedicated offset computator 37 directly to the LMCS controller 39 (not shown). The LMCS controller 39 may additionally or alternatively be configured for controlling the LMCS 35 for displacement of the load towards the target in response to the alignment signal. The main controller 34, LMCS controller 39, crane controller 36 and/or offset computator 37 may all be combined and may contain at least one or a multitude of feedback controllers based on the HMI 31, sensors 32, and/or manual controls 33 inputs.

The control box 38 with the at least one controller 34 is configured for generating an alignment signal in response to the relative movement signal. And generating control signals for controlling displacement of the load towards the target in response to the alignment signal by controlling the load motion compensation system LCMS and/or the crane.

Referring to FIG. 1, the actuators 15 of the LMCS may include a set of control lines or tug lines installed on the tool 14 holding the load 12. The control lines are arranged such that the tool and load may be moved in at least one, preferably at least two degrees of freedom, such as e.g. at least one of pitch, roll, yaw, heave, sway and/or surge as referred to in the nautical field. By applying different tensions on these control lines, the position and orientation of the tool 14 and therewith the load 12 may be controlled in the arranged degrees of freedom. The manner of expressing the Degrees of Freedom may take any form and is not limited to orthogonal systems, as it may include right-handed coordinate systems, left handed coordinate systems, quaternions or axis-angle representations of position and orientation or any other representation.

Alternatively to a cable based system, the LMCS may be provided differently, by, for instance being arranged as a mechanical installation with one or more towers providing several degrees of freedom. For example, the LMCS may be arranged on a tower with a rotary base on the vessel deck, several linear actuators and/or additional rotary joints to move the load with respect to the vessel. Practically, any kinematic chain may be used that is suitable and may be contemplated by those skilled in the art. As long as the LMCS is capable to cause a controlled motion of the load.

Referring to FIGS. 4 and 5, the plurality of sensors 32 of the control system 30 as shown in FIG. 3 will be described in more detail. In the following description, each sensor ‘nn’ may define a local coordinate reference that will be expressed with {Snn}, with ‘Snn’ being the name of the coordinate reference.

In FIG. 4, a first reference sensor 41 is arranged on the tool 14 and provides a reference coordinate system {S41}. A second reference sensor 42 may additionally or alternatively be arranged on the crane 11 and provides a second reference coordinate system {S42}. When reference sensor 42 is arranged as alternative for reference sensor 41, sensor 42 may be regarded as the first reference sensor. The first reference sensor 41 may further be able to provide pose measurements of the tool in absolute world coordinates or geo-position {W} by making use of e.g. a global navigation satellite sensor signal in combination with an inertial measurement device, commonly referred to as a GNSS/INS device. Additionally, correction services such as PPP or RTK or any other available correction may be used to increase the accuracy of the pose measurements. The second reference sensor 42 may provide a remote-sensing measurement of the tool and/or load and translate the pose information of the tool and/or load such that the pose of the load 12 may be expressed in world coordinates {W}. In such case, sensor 42 may sense the tool or load via one or more cameras, lidars or radars remotely or may measure the feedback from an active or passive marker, reflector or any other active or passive system for determining a relative pose between sensor 42 and tool 14 and/or load 12.

Accordingly, the first reference sensor 41 may measure the pose of the tool 14 and/or load 12 directly in world-coordinates {W}, when using the GNSS/INS device. Or, alternatively, the pose and attitude of the tool 14 and/or load 12 may be measured indirectly, with help of the second reference sensor 42 that makes use of the remote-sensing measurement of any feature as described above or of the first reference sensor 41, acting e.g. as active or passive marker or radio beacon and then translating these measurements into world-coordinates. The remote-sensing measurement, for example, may be done by making use of a GNSS/INS combination in the second reference sensor 42 and using a camera, lidar, radar or other remote-sensing technique to infer the relative position of the first reference sensor 41 or of any feature of the tool 14 and/or the load 12 and/or any marker device with regard to second reference sensor 42.

Hence, the pose of {S41} may be measured in {S42} in a relative manner, and if {S42} makes use of an GNSS/INS system, then the pose of {S41} in world coordinates {W} will be easily derived. As can be understood, the arrangement of the first and second reference sensors 41, 42 may be inversed while achieving the same result. In addition, they may be used individually or in combination. Furthermore, additional sensors may be provided, each defining a further reference coordinate system {Snn}. When using multiple reference sensors, these are preferably arranged such that each sensor has a pose that can be expressed in a coordinate system of at least one other reference sensor. As long as at least one of the reference sensors is able to provide world coordinates {W} and each sensor can relate its pose to at least one other reference sensor, either by remote sensing or by inference, all sensors and load pose measurements may be expressed in world coordinates {W}. Furthermore, kinematics techniques may be used, such as e.g. the usage of Denavit Hartenberg parameters and homogeneous transformations in combination with a number of rotational measurements, such as e.g. in a serial robot arm, which may be derived from encoders. As the pose of each sensor may be inferred and expressed in the reference coordinate system of another sensor a kinematic chain can be defined. Likewise, pose measurements i.e. position and orientation, of other elements, such as the crane 11, hoist 13 and/or the vessel 9 may be performed by inference or directly be expressed in world coordinates {W}.

For example, in the embodiment of FIG. 4, a third sensor 43 may be installed on the vessel 9 and provide a third reference coordinate system {S43}, wherein the pose of the first reference sensor 41 and/or second reference 42 may be expressed. If the third reference sensor 43 is provided with a GNSS/INS device, the other reference sensors may do without such device, and still obtain their location expressed in world coordinates {W} via kinematic propagation.

As another example of suitable sensor means, still referring to FIG. 4, a fourth sensor 44 may include a set of rotary and linear encoders and/or position measurement devices, which, together with information of the geometric properties of the crane and its pose with regard to the vessel, may be used to infer the position of second reference sensor 42 in the third reference coordinate system {S43} or, alternatively, in a vessel reference coordinate system {V} that is provided by the vessel construction itself. Any further and/or other combination of sensors suitable to measure the pose may be contemplated, which may also include parameters such as velocity, accelerations and/or jerk of the load. Whereas here all poses have been expressed in an absolute world frame {W} the method described herein may be equally applicable to a case in which no transformation to world reference is performed, but in which a direct relative transform between load and target is measured and controlled by making use of the relative motion signal and/or alignment signal.

Depending on the type of load, e.g. when extending longitudinally, it may be preferred to define one point of the load as a load center, such as a center of gravity, and one point as a load extremity. The load center may then be regarded as a reference center and the position of the load extremity may be described in reference to the load center, which may help to describe the pose of the load. Both the load center and the load extremity may be defined as an origin and providing a corresponding coordinate reference system {LC} and/or {LE}. These may be used interchangeably as an origin. When the load is considered to be a relatively stiff object, the load extremity will move in accordance with the movement of the load center. Particularly in the case of a wind turbine blade, which is a stiff, longitudinal object, a blade center 16 as load center {LC} and a blade root 17 as load extremity {LE} may be defined, as shown in FIG. 4. Each of the blade center and the blade root defining again a coordinate reference system, {BC} and {BR} respectively. As will be understood, using the various sensor reference coordinates, the position of the load extremity may be expressed in or with respect to world coordinates {W} or with respect to any other arbitrarily chosen position on the crane or vessel or load compensation system. Alternatively, the load extremity may also be measured directly from a sensor 45 attached to a tool or may be measured directly by a sensor 46 attached in proximity to the load extremity. Measurement via a sensor 45 from the tool 14 may be preferable for non-stiff objects for which the motion of the load extremity may not easily be determined from the motion of the load center or if the detailed geometry of the load is not known. In such case, a sensor 45 may be arranged to measure the pose of the load end in relation to a sensor coordinate reference {45} and may then express this pose in world coordinates via one of the methods described above, involving either conversion via a GNSS/INS device or via inference or kinematic propagation through other sensors and coordinate reference up to a sensor incorporating a GNSS/INS device that is able to express its own coordinates in world reference. Sensor 45 may be arranged to remotely detect certain geometric features of the load and to determine their relative pose with respect to {45}. This may be done by e.g. one or multiple cameras, lidars or radar or by any combination thereof or by any other known method to determine pose of a structure with regard to a reference. Alternatively, the load end pose may be measured directly by a sensor 46 in a coordinate reference {46} which may then again be either directly transformed to a world reference via a dedicated GNSS/INS device as part of sensor 46 or via inference and/or kinematic propagation towards another sensor incorporating such devices, as described above.

Referring to FIG. 5, an example of a feature detection system 50 and a feature 51 present on the load 12 is shown. The feature detection system 50 is configured for detecting the feature 51, tracking movement of the feature 51, and generating a relative movement signal indicative of relative movement between the target, in this example the nacelle 2, and the load 12. The feature detection system 50 includes a visual detector 52, in this embodiment a camera, and processing means 53, such as a PC, PLC or other general purpose processor, FPGA or micro-processor. Instead of a camera, such as a CCD or CMOS camera, the visual detection means may use one or more LIDAR sensors or one or more RADAR sensors or any combination thereof or any other type of analog or computer enabled vision means. The processing means 53 are configured to process the signals from the visual detector 52 and perform the required processing to track the feature 51 and generate the relative movement signal which may also directly be applied as input to the compensation signal. The feature detection system 50 further includes a communication module 54, such as e.g. a WiFi device or general cable network interface (router, switch, etc.), for transmitting and/or exchanging signals with at least one other component of the control system.

The feature detection system 50 is placed inside or on or near a target 2, in this example the nacelle 2 of FIG. 1. The camera 52 is mounted on a tripod 57 and placed in a stable position on an inner floor 58, or other structural element, of the nacelle 2, and is oriented such that the camera has an outward view towards the load that is to be aligned with the target 2. The exact mounting and mounting devices are not relevant and may be executed differently.

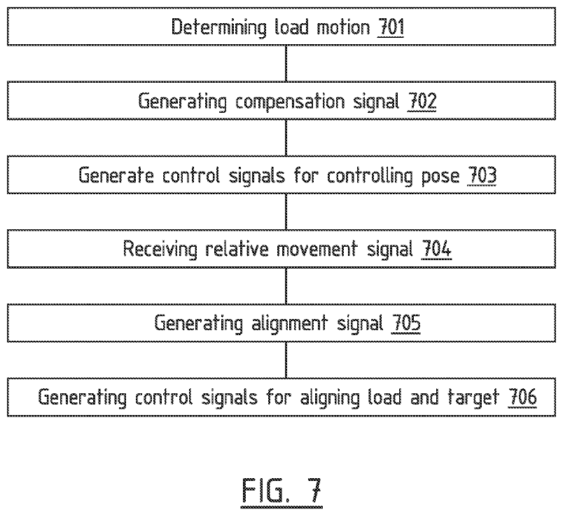

Referring to FIG. 6, a point of view is shown of the feature detection system 50 of FIG. 5, or more specifically of the visual detector 52, looking outward of an opening 59 formed by mounting ring 60 of the nacelle to which the blade is to be aligned and mounted. During a hoisting operation when the load 12 is moved by the crane 11 or by the LMCS for alignment with the target nacelle 2, the feature 51 presented on the load blade 12 will be detected by the camera 52 and movement of the feature 51 will be tracked. During the hoisting operation, the LMCS or the crane will compensate for motion of the load due to wind, etc. as explained above. Also the target, in this example the tower and/or the nacelle, may still experience motion due to wind, etc. As a consequence, the feature 51 may appear to be moving in front of the visual detector 52, regardless of the source of the movement being the load or the target or both, and the visual detector will track the relative movement of the feature with regard to target.

Accordingly, the movement of the feature 51 tracked by the feature detection system 50 expresses a relative movement between the load 12 and the target 2. This relative movement may then be directly applied as an input to control the pose of the load via the crane or the LMCS, e.g. via feedback control (visual servoing). However, as the absolute reference point of the load may be also known from the reference sensor arrangement 32, this relative movement may be expressed in world coordinates {W}. And consequently, it may be used as a target set point for the control system 30. This allows the control system 30 to move the load 12 in synchronization with the target 2.

Still referring to FIG. 6, the feature 51 is shown in more detail. In this example, it is of type ArUco or Charuco marker allowing the visual detector 52 to track relative movement of the feature and therewith of the load 12. The feature on the load may include any set of geometric forms on the load, any marker, decal or print or visual identification thereon, or any other characteristic feature that can be recognized by computer vision and/or LIDAR or RADAR sensor. In addition, the feature may be a structure or structural feature or characteristic of the load or part thereof, or even include or constitute of certain color and/or light intensities of paint, surface treatment, surface roughness, or may be created and/or modulated by any other material or surface or geometry property in the back-scattered information, be it of a structural element of the load, of certain passive markers or active markers or any combination thereof.

As can be understood, a set up reciprocal to FIG. 5, wherein the feature is provided on the target and the feature detection system is provided on the load, is also contemplated.

Referring to FIG. 7, an example of a computer implemented method for controlling alignment of a load suspended from a crane with a target is illustrated. The method includes determining motion 701 of the load in at least one Degree of Freedom and generating at least one compensation signal 702 indicative of motion of the load. In response to the at least one compensation signal, control signals 703 are generated for a crane and/or load motion compensation system LMCS for controlling a, preferably absolute, reference pose of the load within a reference coordinate system provided by a first reference sensor, such as e.g. first, second or third reference sensor 41, 42 or 43. The reference coordinate system may be world coordinates {W} directly or by inference as explained above. In some embodiments, dependent on the configuration of the control system, as e.g. in the case when there are no separate dedicated controllers and just one main controller, the compensation signal 702 may be taken/processed directly as control signals 703. In other embodiments, where e.g. the compensation signal is received by the main controller from remote sensors directly, the generation of control signals 703 requires additional processing. In yet other embodiments, the main controller may receive data indicating motion of the load and generate the compensation signal as a target set point and as input for generating the controls signals 703.

The method further includes receiving 704 from a feature detection system; such as feature detection system 50, a relative movement signal indicative of relative movement between the target and the load. The feature detection system generates the relative movement signal by detecting a feature such as feature 51, and tracking the movement of the feature with respect to the feature detection system. In general, the method further includes generating in response to the relative movement signal control signals 706 for controlling a crane and/or load motion compensation system LMCS to move the load in alignment with the target. As may be understood, the generating of controls signals in steps 702 and 706 may be superimposed, or combined, and may thereby provide a superposition of signals. Accordingly, the order of execution is not necessarily sequentially fixed and any combination of signals may be merged into a single signal. In this example, the method also includes generating an alignment signal 705 in response to the relative movement signal, and wherein generating the control signals 706 for controlling a crane and/or load motion compensation system LMCS is in response to the alignment signal.

With the device and method as described thus far, the load may be aligned with the target; allowing the crane and/or LMCS to move the load towards the target. Basically, the system and method described present the load and target as being mutually in fixated alignment, meaning that a relative motion, such as rotation or translation, of the target is mimicked via the control system to keep the target in the same relative pose to the target. This enables an operator to focus on the task of displacing the load towards the target by manual controls. As the offset between load and target appears as ‘static’ or ‘fixed’ to an operator. And the operator no longer needs to take in account disturbing motions of the target. Accordingly, an operator may provide displacement commands using manual controls to move the load towards the target. During operation the moment and position at which the feature detection system

detects the target and starts tracking provides the relative movement from the moment of detection, there may be an offset present in the alignment. In one embodiment, in order to close the offset during steps of moving the load to the target and initiate installation, the control system includes the manual controls 33 for an operator. This will enable the operator to close any gap remaining due to the offset.

Furthermore, the control system may include a human-machine interface (HMI) to provide visual feedback of the alignment operation. The HMI would then be configured to display a view or images captured by the feature detection system, or alternatively by e.g. one or more cameras. The operator could use the visual feedback during the final steps to close the gap due the offset. Alternatively, such feedback could be provided virtually, by means of a 3D visualization or virtual or augmented reality displays which may be combined with camera feedback signals.

In another embodiment, the control system may apply a pattern classification system to views or images captured by the feature detection system in order to identify if the load is in a position that overlays with the target installation points.

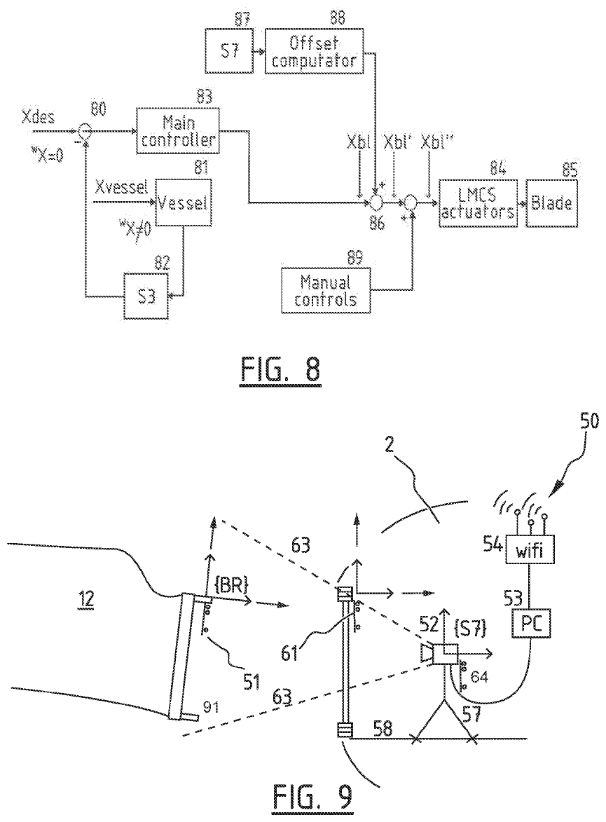

Referring to FIG. 8; an example of a control scheme of an extended control system is illustrated. An initial setpoint Xdes is input at point 80 and corrected for a vessel position of reference sensor 82 sensing the position of the vessel 81. The input 80 is used by the main controller 83 to control the LMCS actuators 84 which cause the blade 85 to move resulting in a change of blade position Xbl. Alternatively, the main controller 83 could control the crane to cause the blade 85 to move, or both. Alternatively to using S3 82, here, the relative movement signal of the feature detection signal 52 may be used directly in a feedback control manner, such as e.g. visual servoing. Alternatively, an offset computator 88 processes the relative movement signal of the feature detection system 87, similar to the one described in relation to FIG. 5, and computes a new setpoint to correct blade position Xbl to the new position Xbl′ with its setpoint. Also in such an embodiment, an operator input from manual controls 89 may in turn still be applied to correct the setpoint to Xbl″ to minimize an offset. The setpoints are then applied to e.g. the LMCS actuators as a control signal. They may be summed to the input 80 of the main controller (not shown).

Referring to FIG. 9, which shows the same elements as shown in FIG. 6, the load alignment system may additionally include a second feature 61; this in addition to the feature 51 on the load. The second feature, in FIG. 9 a feature plate 61, is located within the view 63 or line of sight of the feature detection system, in this embodiment the visual detector 52. The feature plate 61 forms part of the load alignment system and is arranged where the feature detection system is provided, in this embodiment in the nacelle 2. The feature plate 61 is further arranged such that the feature detection system 52 detects the second feature 61 as a target reference point, or as a lead towards a target reference point on a structure. In the example of FIG. 9, the blade is provided with bolts 91 instead of holes 71.

In order to achieve full alignment, wherein mounting positions of the load are positioned facing corresponding mounting positions of the target, such as e.g. bolts in holes, further movement may be required. This in order to perform an assembly. Thereto the first feature 51, here also embodied as a feature plate, and the second feature plate 61 are required to satisfy certain conditions, as it requires that the feature detection system 52 is able to determine geometrical relationship between structural parts of both the load and the target.

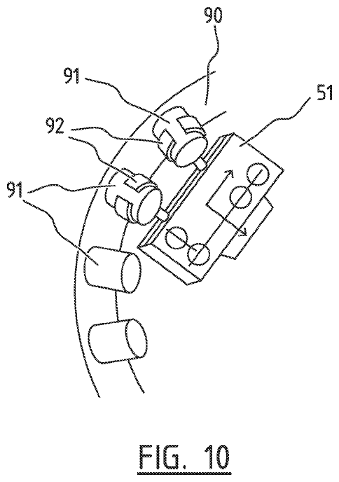

Referring to FIG. 10, part of a circular edge 90 of a load, in this example a wind turbine blade, is shown having bolts 91 extending from the edge 90 that are to engage holes of a corresponding circular edge of the target, in this example, a wind turbine nacelle. In this example, the feature plate 51 is mounted onto the bolts 91 by means of clamps 92, which allow easy mounting and disassembly before and/or after merging of blade and nacelle. However, other means for mounting the feature plate 51 onto the bolts 91 may be contemplated. Other structural elements onto where the feature plate 51 is mounted may be contemplated, as long as a geometric relationship between the structural elements and feature plate is or may be known or derived. Or these may be inferred, e.g. from CAD and design data of the load, target and/or feature plate. Alternatively, the feature plate may be defined as one or more visual features that may be detected directly, such as e.g. holes or bolts that will be detected by computer vision algorithms, by lidar, radar or otherwise. Similarly, this also applies to the feature plate 62 that is to be mounted to the target. In other examples, where both the load and the target include holes and bolts are to be pushed through the holes of both the load and target, as for example in the example of FIG. 6, feature plates 51, 61 may be mounted on or near the holes 62, 71 in a fixed and inferable geometric relationship. As an example of a geometric relationship, the structural relationship of the bolts and/or holes me be used. This may for example be extracted from CAD data, drawings, design information or from other 2D, 3D or non-dimensional model data, such that it can be matched with feature detection measurements.

Regardless of the specific details of how the feature plates 51, 61 are mounted, the location and/or pose i.e. position and orientation where the feature plate is mounted respectively onto the load or target needs to be known or at least be inferable from design. This in order to understand the geometrical relationship between the feature plate and the corresponding mounting positions of the load and the target. As e.g. the blade needs to be installed onto the nacelle with a predetermined position and/or orientation.

With the load alignment system expanded with the second feature and arranged as described, the offset computator may be configured to use the target reference point and geometric relationships and determine an aligned pose of the load. That is a pose of the load 12 that allows installation of the load onto the target without further offset to be compensated. For example, in the example of FIG. 6, the mounting ring 60 is provided with bolt holes 62 which is to be aligned with bolt holes 71 on a mounting ring 70 of the blade 12. The aligned pose would indicate that the bolt holes of the load and of the target are in alignment; allowing e.g. through bolts to be guided through the holes. Hence, with the aligned pose of the load determined, this may be applied, e.g. stepwise, when generating the alignment signal in response to the relative movement signal. The alignment signal may involve a trajectory planner and/or a trajectory controller and may also compute the alignment trajectory in one step or continuously at every calculation step.

With this expanded load alignment system of FIG. 9 including the second feature, the manual controls 89 of FIG. 8 may be replaced by a trajectory controller instead which may be configured to receive any input from the system. Alternatively, the trajectory controller may be used to ‘guide’ the manual motion along the path of the predetermined or on-line computed trajectory. The trajectory controller taking the output of the offset computator and generating a trajectory such as to displace the load towards engaging with the target. The trajectory controller output from the alignment system 50 generating a path, or one or multiple set-points, for the crane or for the LMCS or for both by generating the alignment signal taking in account the aligned pose.

Referring again to FIG. 9, in order to further enhance the determination of the geometrical relationship between the first feature 51 and feature plate 61 and the feature detection system 52, a third feature 64 or feature plate may be provided. A picture showing the second feature 61 and third feature 64 in a single view allows to determine the pose offset of the feature detection system 52 in relation to the target 2, or at least a relevant mounting position of the target that is indicated by the pose inferable via feature plate 61. In the example of FIG. 9, where the feature detection system 52 is positioned inside a wind turbine nacelle an operator may just take the picture and upload it or provide it digitally by any means to the control system 30. Or alternatively to an operator or computing means who or which will extract the relevant offsets, such as e.g. {S64} with respect to {S61}, from the picture by additional computations that are known to those skilled in the art. With the picture available and/or by knowing the relative offsets between the local coordinate system of both feature plates 61, 64, and by knowing the offset from 62 to the sensor location of 52, the relative offset from the camera—or sensor—frame of 52 to the structurally relevant location may be established more accurately. The picture showing both features 61, 64 present on the target may be taken in advance of performing the alignment process. Alternatively, they may be taken or processed on the fly. In addition, in other embodiments, relevant parameters may be entered into the control system by hand or by a secondary system.

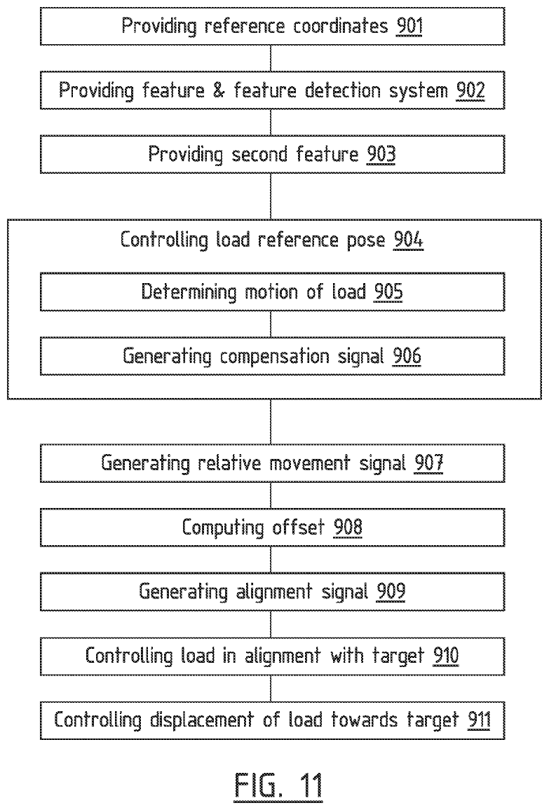

Referring to FIG. 11, another example of a method for controlling alignment of a load suspended from a crane with a target is illustrated. The method includes providing by a first sensor a reference coordinate system 901. The reference coordinate system may be world coordinates {W} directly or by inference as explained above. The method further includes providing a feature 902, such as feature 51, either on the load 12 or on the target 2 and providing a feature detection system 50 respectively on the target 2 or on the load 12. The method includes controlling a, preferably absolute, reference pose 904 of the load within the reference coordinate system and wherein controlling the reference pose 904 of the load is in response to the at least one compensation signal. As will be understood, these steps of controlling the reference pose are performed in a continuous, re-iterative manner. The method includes the feature detection system detecting the feature, tracking movement of the feature, and generating a relative movement signal 907 indicative of relative movement between the target and the load. The method further includes generating an alignment signal 909 in response to the relative movement signal and controlling 910 in response to the alignment signal a crane and/or load motion compensation system for moving the load in alignment with the target.

As seen in FIG. 9, the step of controlling the reference pose 904, may include two further steps or sub processes, determining motion of the load 905 in at least one and preferably at least two, or even more preferably at least three, Degrees of Freedom, and generating at least one compensation signal 906 indicative of motion of the load.

Still referring to FIG. 9, an example of an enhanced method is illustrated. Thereto method includes providing 903 a second feature, and preferably a third feature, such as second feature 61 and third feature 64. The second feature is provided where the feature detection system is, and such that the feature detection system detects the second feature as a target reference point. Preferably, also the third feature is detected as a target reference point or a least to be used to derive or infer relevant transformations. The method further includes computing an offset 908 of the load based on the target reference point and applying the computed offset when generating the alignment signal 909. In the enhanced example, the method further includes generating a displacement signal in response to a computed offset and/or input from manual controls controlling, in response to the displacement signal, a crane and/or LMCS for displacement of the load towards the target.

The control system with the expanded load alignment system including the second and preferably third feature and the method for alignment corresponding to such a control system may provide the benefit of being able to perform the alignment of the load and the target while taking in account an offset, if present, from the moment the feature detection system detects the feature. This is due to the second feature and/or the third feature for which world coordinates may be inferred from the position in relation to other reference sensors and which allow to determine exact geometric relationships between all sensors, features and structural elements of interest of the load and target. The world coordinate system reference may be provided directly when a feature detection system is provided with a GNSS/INS device, as e.g. described above in relation to FIGS. 4 and 5.

Although the present invention has been described above with reference to specific embodiments, it is not intended to be limited to the specific form set forth herein. Rather, the invention is limited only by the accompanying claims and, other embodiments than the specific embodiments above are equally possible within the scope of these appended claims.

Furthermore, although exemplary embodiments have been described above in some exemplary combination of components and/or functions, it should be appreciated that, alternative embodiments may be provided by different combinations of members and/or functions without departing from the scope of the present disclosure. For example, the Load Motion Compensation System may take a form different from that as disclosed in e.g. WO2021002749A1. In addition, it is specifically contemplated that a particular feature described, either individually or as part of an embodiment, can be combined with other individually described features, or parts of other embodiments.

The present disclosure further relates to the embodiments reflected in the following clauses:

c1. A computer implemented method for controlling alignment of a load suspended from a crane with a target, comprising:
determining motion (701) of the load in at least one Degree of Freedom;
generating at least one compensation signal (702) indicative of motion of the load; and
generating, in response to the at least one compensation signal, control signals (703) for a crane and/or load motion compensation system LMCS for controlling a reference pose of the load within a reference coordinate system provided by a first reference sensor;
receiving (704) from a feature detection system a relative movement signal indicative of relative movement between the target and the load;
generating in response to the relative movement signal, control signals (706) for controlling a crane and/or load motion compensation system LMCS for moving the load in alignment with the target.
   c2. The method according to clause c1, further comprising:
generating an alignment signal (705) in response to the relative movement signal; and
wherein generating the control signals (706) for controlling a crane and/or load motion compensation system LMCS is in response to the alignment signal.
c3. The computer implemented method according to clause c1 or c2, further comprising:
the feature detection system generating the relative movement signal by detecting the feature that is provided on the load and tracking movement of the feature.
   c4. The computer implemented method according to any one of the preceding clauses, further comprising:
generating a displacement signal in response to a computed offset and/or input from manual controls; and
generating, in response to the displacement signal, control signals for controlling a crane and/or LMCS for displacement of the load with the target.
   c5. A control box for controlling alignment of a load suspended from a crane with a target, comprising:
at least one controller (34) configured for carrying out the method of any one of clauses c1-c4.
   c6. A control system for controlling alignment of a load suspended from a crane with a target, comprising:
at least one reference sensor (41, 42, 43) for providing a reference coordinate system ({S41}, {S42}, {S43});
a load motion compensation system LMCS (35) for controlling a reference pose of the load (12) in the reference coordinate system ({S41}, {S42}, {S43}) comprising:
at least one motion sensor (41) arranged for determining movement in at least one Degrees of Freedom and generating at least one compensation signal indicative of motion of the load; and
at least one motion compensation actuator (15) arranged for controlling a pose of the load in response to the at least one compensation signal; and
a load alignment system, comprising:
a first feature (51) arranged on the load (12) or on the target (2);
a feature detection system (50) arranged respectively on the target (2) or on the load (12), and configured to detect the feature (51), tracking movement of the feature (51), and to generate a relative movement signal indicative of relative movement between the target (2) and the load (12); and
comprising at least one controller (34), wherein the at least one controller (34) is configured for:
generating an alignment signal in response to the relative movement signal; and
generating in response to the alignment signal control signals for controlling the crane and/or the load motion compensation system LCMS for moving the load in alignment with the target.
   c7. The control system according to clause c6, wherein the at least one controller is further configured for:
generating a displacement signal in response to a computed offset and/or input from manual controls; and
generating, in response to the displacement signal, control signals for controlling a crane and/or the load motion compensation system LMCS for displacement of the load towards the target.
   c8. The control system according to clause c6 or c7, wherein the at least one controller comprises:
a load motion compensation system LMCS controller (39) for generating the LCMS control signals; and/or
an offset computator (37, 88) for computing an offset; and/or
a crane controller (36) for generating the crane control signals.
   c9. The control system according to any one of clauses c6-c8, wherein
the control system comprises multiple reference sensors;
wherein the multiple reference sensors are arranged such that each sensor has a position that is expressed in a coordinate system of at least one other reference sensor; and
wherein at least one reference sensor provides world coordinates.
   c10. The control system according to any one of clauses c6-c9, wherein the load motion compensation system (35) is configured for processing the compensation signal and activating the motion compensation actuator for controlling the pose of the load at the reference pose.
   c11. The control system according to any one of clauses c6-c10, further comprising a human-machine interface HMI, wherein the human-machine interface is configured for displaying a view captured by the feature detection system; and/or
further comprising manual controls for an operator.
   c12. The control system according to any one of clauses c6-c11, wherein the load alignment system further comprises:
a second feature arranged where the feature detection system is provided, such that the feature detection system detects the second feature as a target reference point; and
preferably a third feature arranged on the feature detection system, such that the second and third feature may be captured in a single camera view; and
wherein the at least one controller is configured for computing an offset based on at least the first and second feature.
   c13. A method for controlling alignment of a load suspended from a crane with a target, comprising:
providing by a first sensor (901) a reference coordinate system;
providing a feature on the load (902) or on the target and providing a feature detection system respectively on the target or on the load;
controlling a reference pose (904) of the load within the reference coordinate system;
the feature detection system detecting the feature, tracking movement of the feature, and generating a relative movement signal (907) indicative of relative movement between the target and the load; and
generating an alignment signal (909) in response to the relative movement signal; and
controlling (910) in response to the alignment signal a crane and/or load motion compensation system for moving the load in alignment with the target.
   c14. The method according to clause c13, wherein controlling the reference pose (704) comprises: determining motion (905) of the load in at least two Degrees of Freedom;
generating at least one compensation signal (906) indicative of motion of the load; and
wherein controlling the reference pose of the load is in response to the at least one compensation signal.
   c15. The method according to any one of clauses c13-c14, comprising:
providing a second feature (903) where the feature detection system is provided, and more preferably a third feature; such that the feature detection system detects the second feature; and preferably third feature, as a target reference point;
   c16. The method according to any one of clauses c13-c15, further comprising:
generating a displacement signal in response to a computed offset and/or input from manual controls; and
controlling, in response to the displacement signal, a crane and/or LMCS for displacement of the load towards the target.
   c17. A crane comprising a control system according to any one of clauses c6-c12.
   c18. A vessel comprising a crane and a control system according to any one of clauses c6-c12.
   c19. A computer program product comprising instructions which, when the program is executed by a computer, cause the computer to carry out the method of clauses c1-c4 or clauses c13-c16.
   c20. A computer-readable data carrier having stored thereon the computer program product of clause c19.

1. A control system for controlling motion compensation of a load (12) that is suspended from a crane (11) and is moving relative to a fixed external reference system ({W}) and for concurrently controlling alignment of the load (12) with a target (2), the control system comprising:
a load motion compensation system, LMCS, (35) for controlling a reference pose of the load (12) relative to the external reference system ({W}), wherein the LMCS (35) comprises:
at least one motion sensor (41, 42, 43, 44, 45) arranged for determining movement of the load (12) in at least one Degrees of Freedom relative to the external reference system ({W}) and for generating at least one compensation signal (702) indicative of motion of the load; and
at least one LMCS actuator (15, 84) arranged for controlling a pose of the load relative to the external reference system ({W}) and in response to the at least one compensation signal (702); and
a load alignment system, comprising:
a first feature (51) arranged on/in the load (12) or on/in the target (2);
a feature detection system (50) arranged respectively on/in the target (2) or on/in the load (12), and configured to detect and track movement of the feature (51), and to generate a relative movement signal (907) indicative of relative movement between the target (2) and the load (12);
wherein the control system comprises at least one controller (34, 39) configured to:
generate an alignment signal (705) in response to the relative movement signal (907), the alignment signal being distinct from the compensation signal (702); and to
generate, in response to the alignment signal (705), control signals (706) for controlling the crane and/or the at least one LCMS actuator (84) in order to move the load in alignment with the target.

2. The control system according to claim 1, wherein the at least one motion sensor (41, 42, 43, 44, 45) is configured to determine absolute movement of a reference point ({BR}) on the load (12) relative to the fixed external reference system ({W}), and to generate the compensation signal (702) based on said absolute movement;
wherein the feature detection system (50) is configured to detect and track the feature (51) located on the load (12) or on the target (2), and is configured to generate the relative movement signal (907) indicative of relative movement between the reference point ({BR}) on the load (12) with respect to a target reference frame ({S7}) associated with the target (2);
and wherein the control system is configured to express the relative movement signal (907) in world coordinates, based on a determined pose of the reference point ({BR}) relative to the external reference system ({W}) as well as based on a measured relative pose between the reference point ({BR}) with respect to the local reference frame ({S7}), to derive the control signals (706) for controlling the crane and/or the at least one LCMS actuator (84) used for moving the load (12) in synchronization with the target (2).

3. The control system according to claim 1 or 2, wherein the control system (30) is configured to combine the compensation signal (702) and the alignment signal (705) to yield a superposition of signals or a merged signal (706), and using the superposition of signals or merged signal to control the crane (11) and/or the at least one LMCS actuator (84) to hold the load (12) in alignment with the target by mimicking relative rotation and translation between the load (12) and the target (2) via dynamically repositioning and holding the load (12) in essentially the same relative pose including a static offset relative to the target.

4. The control system according to any one of claims 1-3, wherein the feature detection system (50) includes:
a visual detector (52), positioned on or in the target (2) and with a field of view (63) directed towards the first feature (51) arranged on/in the load (12), and
a processor (53), configured to process detector signals received from the visual detector (52) to allow tracking of the feature (51) and generating of the relative movement signal (907).

5. The control system according to any one of claims 1-4, wherein the load is a wind turbine blade (12) suspended from the crane (11) that is mounted on a vessel (9), the wind turbine blade (12) being moveable relative to the external reference system ({W});
wherein the target is a nacelle (2) of a wind turbine generator (1);
and wherein the wind turbine blade (12) is elongated and defines a blade root (17) at one distal end (90) and associated with a blade root reference frame ({BR}).

6. The control system according to claim 5, wherein the feature detection system (50) is provided inside the nacelle (2) with the visual detector (52) in a fixed pose, for instance mounted on a tripod (57) that is placed on a floor inside the nacelle (2), the visual detector (52) having a field of view (63) directed outward through a mounting ring (60) of the nacelle (2) and viewing towards the feature (51) provided on the blade root (17) in a fixed position relative to the blade root reference frame ({BR}), wherein optionally the feature (51) is an ArUco marker, a ChArUco marker, or a plate provided with a plurality of structural features in a fixed geometric arrangement that is known to the control system.

7. The control system according to claim 6, wherein the load alignment system additionally includes a feature plate (61) located inside the nacelle (2) and within the field of view (63) of the visual detector (52), wherein the feature detection system (50) is configured to detect the feature plate (61) as a target reference point associated with a local reference system ({S7}) of the visual detector (52) located in a fixed pose inside the nacelle (2).

8. The control system according to any one of claims 5-7, wherein the wind turbine blade (12) includes blade mounting members (91), such as bolts, provided at the distal end (90), the blade mounting members (91) being configured to be connected to corresponding mounting members (62), such as bolt holes, provided at mounting positions (60) at the nacelle (2);
and wherein the feature plate (51) is removably mounted onto the blade mounting members (91) by means of clamps (92) to allow the feature plate (51) to be removed after fixing the wind turbine blade (12) to the nacelle (2).

9. The control system according to any one of claims 1-8, wherein the at least one controller (34, 39) is further configured to:
generate a displacement signal in response to a computed offset and/or input from manual controls (33); and to
generate, in response to the displacement signal, control signals for controlling a crane and/or the load motion compensation system LMCS for displacement of the load towards the target.

10. The control system according to any one of claims 1-9, wherein the at least one controller (34, 39) comprises:
a LMCS controller (39) for generating the LCMS control signals; and/or
an offset computator (37, 88) for computing an offset; and/or
a crane controller (36) for generating crane control signals.

11. The control system according to any one of claims 1-10, wherein
the control system comprises multiple reference sensors (41, 42, 43, 44, 45);
wherein the multiple reference sensors are arranged such that each sensor has a position that is expressed in a coordinate system of at least one other reference sensor; and
wherein at least one reference sensor provides world coordinates.

12. The control system according to any one of claims 1-11, further comprising a human-machine interface, HMI, (31), wherein the human-machine interface is configured to display a view captured by the feature detection system; and/or
further comprising manual controls for an operator.

13. The control system according to any one of claims 1-12, wherein the load alignment system further comprises:
a second feature (61) arranged where the feature detection system (50) is provided, such that the feature detection system detects the second feature as a target reference point; and
wherein the at least one controller is configured to compute an offset based on at least the first and second features.

14. The control system according to claims 6 and 13, wherein the feature detection system (50) comprises a third feature (64) arranged on the visual detector (52) at a location that allows the second and third features (61, 64) to be captured in an single image acquired by an operator located at or in the nacelle (2), and wherein the control system (30) is configured to receive the image including both the second and third features (61, 64) and derive from the image a pose offset of the visual detector (52) relative to the nacelle (2) and the second feature (61).

15. A method for controlling alignment of a load suspended from a crane with a target, comprising:
determining motion (701) of the load in at least one Degree of Freedom;
generating at least one compensation signal (702) indicative of motion of the load; and
generating, in response to the at least one compensation signal, control signals (703) for a crane and/or load motion compensation system, LMCS, for controlling a reference pose of the load within a reference coordinate system provided by a first reference sensor;
receiving (704) from a feature detection system a relative movement signal indicative of relative movement between the target and the load;
generating in response to the relative movement signal, control signals (706) for controlling a crane and/or load motion compensation system LMCS for moving the load in alignment with the target.

16. The method according to claim 15, further comprising:
generating an alignment signal (705) in response to the relative movement signal; and
wherein generating the control signals (706) for controlling a crane and/or load motion compensation system LMCS is in response to the alignment signal.

17. The method according to claim 15 or 16, further comprising:
the feature detection system generating the relative movement signal by detecting the feature that is provided on the load and tracking movement of the feature.

18. The method according to any one of claims 15-17, further comprising:
generating a displacement signal in response to a computed offset and/or input from manual controls; and
generating, in response to the displacement signal, control signals for controlling a crane and/or LMCS for displacement of the load with the target.

19. A method for controlling alignment of a load suspended from a crane with a target, comprising:
providing by a first sensor (901) a reference coordinate system;
providing a feature on the load (902) or on the target and providing a feature detection system respectively on the target or on the load:
controlling a reference pose (904) of the load within the reference coordinate system;
the feature detection system detecting the feature, tracking movement of the feature, and generating a relative movement signal (907) indicative of relative movement between the target and the load; and
generating an alignment signal (909) in response to the relative movement signal; and
controlling (910) in response to the alignment signal a crane and/or load motion compensation system for moving the load in alignment with the target.

20. The method according to claim 19, wherein controlling the reference pose (704) comprises:
determining motion (905) of the load in at least two Degrees of Freedom;
generating at least one compensation signal (906) indicative of motion of the load; and
wherein controlling the reference pose of the load is in response to the at least one compensation signal.

21. The method according to claim 19 or 20, comprising:
providing a second feature (903) where the feature detection system is provided, and more preferably a third feature; such that the feature detection system detects the second feature;
and preferably third feature, as a target reference point;

22. The method according to any one of claims 19-21, further comprising:
generating a displacement signal in response to a computed offset and/or input from manual controls; and
controlling, in response to the displacement signal, a crane and/or LMCS for displacement of the load towards the target.

23. A crane comprising a control system according to any one of claims 1-14.

24. A vessel comprising a crane and a control system according to any one of claims 1-14.

25. A computer program product comprising instructions which, when the program is executed by a computer, cause the computer to carry out the method of any one of claims 15-22.

26. A computer-readable data carrier having stored thereon the computer program product of claim 25.
